(19) United States
(12) Patent Application Publication
(10) Pub. No.: US 2025/0360729 A1
(43) Pub. Date: Nov. 27, 2025

(54) PRINTING SYSTEM, CONTROL METHOD FOR PRINTING SYSTEM, AND STORAGE MEDIUM

(71) Applicant: CANON KABUSHIKI KAISHA, Tokyo (JP)

(72) Inventor: YOSHIJI KANAMOTO, Tokyo (JP)

(21) Appl. No.: 19/199,062

(22) Filed: May 5, 2025

(30) Foreign Application Priority Data
May 24, 2024 (JP) 2024-084791

(51) Int. Cl. B41J 11/00; B41J 3/46; G03G 15/00

(52) U.S. Cl. CPC B41J 11/006; B41J 3/46; G03G 15/70

(57) ABSTRACT

A printing system includes an image forming apparatus and a sheet conveying apparatus configured to convey a sheet conveyed from the image forming apparatus, wherein the sheet conveying apparatus includes a first sheet conveying path and a second sheet conveying path, and wherein the sheet conveying apparatus includes a first display section that indicates a sheet jam in the first sheet conveying path and a second display section that indicates a sheet jam in the second sheet conveying path.

### BACKGROUND OF THE INVENTION

### Field of the Invention

The present invention relates to a printing system, a control method for the printing system, and a storage medium.

### Description of the Related Art

In the related art, there is a technique for a printing system including an image forming apparatus and a sheet conveying apparatus that conveys sheets transported from the image forming apparatus. In this system, the image forming apparatus provides a notification of the occurrence of a sheet jam using its own operation section.

Japanese Patent Laid-Open No. 2019-211594 discloses an image forming apparatus including a sheet conveying apparatus, in which both of a sheet jam that has occurred in the image forming apparatus and a sheet jam that has occurred in the sheet conveying apparatus are indicated only by an operation section of the image forming apparatus.

In case of a sheet jam, the operator has to remove the jammed sheet from the sheet conveying path to start the image formation again.

The operator has to move to the position of the operation section of the image forming apparatus to determine the location of the jam.

### SUMMARY OF THE INVENTION

A printing system according to an aspect of the present invention includes an image forming apparatus and a sheet conveying apparatus configured to convey a sheet conveyed from the image forming apparatus, wherein the sheet conveying apparatus includes a first sheet conveying path and a second sheet conveying path, and wherein the sheet conveying apparatus includes a first display section that indicates a sheet jam in the first sheet conveying path and a second display section that indicates a sheet jam in the second sheet conveying path.

Further features of the present invention will become apparent from the following description of exemplary embodiments with reference to the attached drawings.

### BRIEF DESCRIPTION OF THE DRAWINGS

FIG. 1 is a block diagram illustrating the entire printing system according to a first embodiment.

FIG. 2A is a functional block diagram illustrating the internal configuration of a digital front end (DFE) according to the first embodiment.

FIG. 2B is a functional block diagram illustrating the internal configuration of s printer according to the first embodiment.

FIGS. 3A to 3D are block diagrams of the modules constituting the printer according to the first embodiment.

FIG. 4A is a diagram for illustrating the configuration and the positional relationship of the conveying paths in the printer according to the first embodiment.

FIG. 4B is a table showing the correspondence relationship among the modules, LEDs, conveying paths, and sensors according to the first embodiment.

FIG. 5A is a diagram illustrating an example of the jam that has occurred in the printing system according to the first embodiment.

FIG. 5B is a diagram illustrating an example of indication of the jam that has occurred in the printing system according to the first embodiment.

FIG. 6 is a first flowchart illustrating the first embodiment.

FIG. 7 is a second flowchart illustrating the first embodiment.

FIG. 8A is a third flowchart for the modules other than the image forming section according to the first embodiment.

FIG. 8B is a third flowchart for the image forming section according to the first embodiment.

FIG. 9A is a diagram illustrating an example of the jam that has occurred in a printing system according to a second embodiment.

FIG. 9B is a diagram illustrating an example of indication of the jam that has occurred in the printing system according to the second embodiment.

FIG. 10 is a flowchart illustrating a third embodiment.

### DESCRIPTION OF THE EMBODIMENTS

### First Embodiment

First, a first embodiment of the present invention will be described.

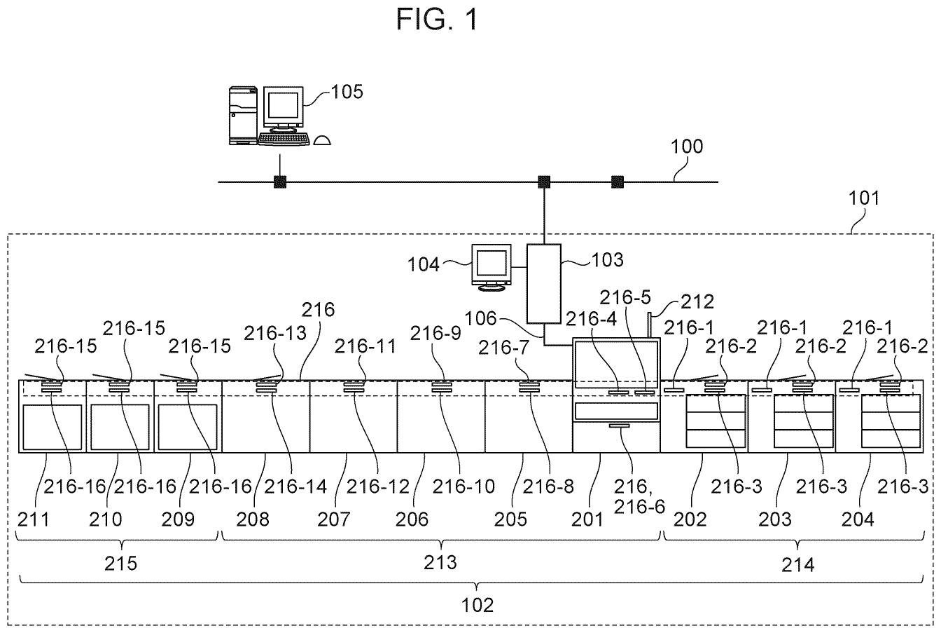

FIG. 1 is a block diagram illustrating a print processing system according to this embodiment. The print processing system according to this embodiment includes an image forming apparatus 101 and a personal computer (PC) 105. The image forming apparatus 101 includes a printer 102, which is an example of a printing system, a digital front end (DFE) 103, and an operation section 104.

The image forming apparatus 101 is communicably connected to the PC 105, which is an example of an information processing apparatus, via a first network 100. In this embodiment, the printer 102 is an ink-jet printer; however, the printer 102 may be an electrophotographic printer.

Although FIG. 1 shows an example in which a single PC 105 is provided in the print processing system, the image forming apparatus 101 and multiple information processing apparatuses may be communicably connected via the first network 100. The print processing system of this embodiment includes the image forming apparatus 101 and the PC 105. This, however, is illustrative only. For example, the image forming apparatus 101 may solely execute the image forming process and may singly constitute a print processing system. Specifically, the image forming apparatus 101 may print image data stored in a memory in either the DFE 103 or the image forming apparatus 101 in response to an instruction from the operation section 104 of the image forming apparatus 101.

The PC 105 may execute various programs, for example, an application program for generating image data to be printed by the image forming apparatus 101. The PC 105 has a printer driver or workflow software installed, which converts print data into a printer language interpretable by the image forming apparatus 101. The operator who wants to print may provide a print instruction via an application. Based on the print instruction, the printer driver or the workflow software converts the data output from the application into print data interpretable by the image forming apparatus 101 and sends the print data to the image forming apparatus 101 connected to the first network 100.

Although this embodiment illustrates the PC as an example of the information processing apparatus, the information processing apparatus may be a personal digital assistant, such as a smartphone or a tablet terminal. A method for sending print data to the image forming apparatus 101 may be modified as appropriate. For example, the PC 105 may send print data to the image forming apparatus 101 via a cloud server.

Next, the printer 102 will be described. The printer 102 is an example of a printing system and has a printing function for printing images on sheets based on image data. The printer 102 includes multiple sheet storage sections (sheet feeding sections) and multiple sheet discharge sections. The printer 102 feeds sheets from one of the multiple sheet storage sections, conveys the fed sheets, prints images on the conveyed sheets, and discharges the sheets on which images are printed to one of the multiple sheet discharge sections. Examples of sheets that can be conveyed by the printer 102 include plain paper, cardboards, and coated paper.

The image forming apparatus 101 may execute a print job to print an image on a sheet based on image data received from the PC 105. In this embodiment, the printer 102 may be a multifunctional printer including a reading device, such as a scanner. In that case, the printer 102 may execute a copy job to print an image on a sheet based on the image data of a document scanned by the scanner.

In the image forming apparatus 101 of this embodiment, the DFE 103 including the operation section 104 is connected to the printer 102 via a second network 106. Also, FIG. 1 illustrates an example in which the printer 102 is connected to the first network 100 via the DFE 103.

In other words, in the configuration of FIG. 1, the printer 102 receives an instruction to execute a print job from the PC 105 via the DFE 103. The DFE 103 and the printer 102 are connected via the second network 106, whereby print data, various commands, status notifications, and other information are transmitted and received via the second network 106.

The printer 102 is configured such that devices (modules) having multiple different functions are mutually connected to allow for various sheet processes. The components of the printer 102 will be described hereinbelow.

The printer 102 includes a sheet feeding unit 214, a printing unit 213, and a sheet discharge unit 215. The printing unit 213 includes an image forming section 201, a first fixing section (a first fixing device) 205, a second fixing section (a second fixing device) 206, a cooling section (a cooling device) 207, and a reversing section (a reversing device) 208.

The image forming section 201 includes ink-jet heads of individual colors arranged linearly perpendicular to the conveying direction. The ink-jet heads eject droplets from above onto the sheet conveyed below the heads according to the image data to form an image on the sheet. At that time, the ink-jet heads eject primer before ejecting inks of individual colors to improve the landing performance and fixing performance of the droplets. The image forming section 201 in FIG. 1 performs an image forming process for yellow (Y), magenta (M), cyan (C), and black (K) colors. However, in addition to these colors, the image forming section 201 may also be configured to form images using inks of any special colors called spot colors, or additional colors like orange, violet, and green.

The sheet on which a full-color image is formed is conveyed to the first fixing section 205 and the second fixing section 206. The first fixing section 205 and the second fixing section 206 house a heat source such as a heater and dry the ink on the sheet, on which an image has been formed, with heat, thereby fixing the ink onto the sheet. Next, the sheet is conveyed to the cooling section 207, where the cooling section 207 cools the heated sheet to decrease the temperature of the sheet.

The reversing section 208 is a module used to turn the sheet inside out to form an image on the back of the sheet, and to convey the sheet with the front and back reversed to the image forming section 201 again.

The sheet feeding unit 214 is used to continuously supply the sheets on which the printing unit 213 forms images. FIG. 1 illustrates a state in which three sheet feeding sections 202, 203, and 204 are connected. The sheet discharge unit 215 is used to accumulate printed output. In the example shown in FIG. 1, the sheet discharge unit 215 includes three connected sheet discharge sections 209, 210, and 211. Each sheet feeding section is also referred to as a sheet feeding device. Each sheet discharge section is also referred to as a sheet discharge device.

A notification unit (lamp) 212 is used to indicate the status of the printer 102 by lighting, which is, in the system of FIG. 1, controlled by the DFE 103.

The above components of the printer 102 each include a light emitting diode (LED) 216. Each LED 216 expresses the event generated in each section where the LED 216 is disposed using, for example, lighting, or the color or pattern of lighting. The LED 216 is an example of a notification unit. However, any notification unit capable of notifying the operator of the event may be used instead of the LED.

Specifically, assume a case where a sheet guided to the second fixing section 206 causes a jam therein. In that case, the system according to this embodiment turns on an LED (216-9) or LED (216-10) of the second fixing section 206 in red to notify the operator that an event that printing is difficult to continue because of the jam that has occurred in the second fixing section 206.

A second example is as follows. If the sheet supply runs out in the sheet feeding section (202, 203, 204) during the printing job, and the process cannot be continued, one of the LEDs 216-3 of the sheet feeding sections 202, 203, and 204 is turned on in red to notify the operator of the sheet running-out.

A third example is as follows. If the sheet stacking amount in the sheet discharge section (209, 210, 211) reaches a predetermined amount during the printing job, and no more sheets can be stacked, one of the LEDs 216-16 of the sheet discharge sections 209, 210, and 211 is turned on in red. This enables the operator to be notified that no more sheets can be stacked.

The event that has occurred in the printer 102 can be indicated by the operation section 104 of the DFE 103. However, only by the indication using the operation section 104, the operator has to move to the operation section 104 to determine in which of the multiple units constituting the printer 102 the event has occurred and what event has occurred. For example, a sheet jam may occur when the operator is distant from the image forming apparatus 101 to convey discharged printed matter. In that case, the operator has to remove the sheet to start printing again, and has to move to the position of the operation section 104 to determine the position of the sheet jam. When the information is presented on an operation section 290 (described below) of the image forming section 201, the operator has to move to the operation section 290 of the image forming section 201 to see the information.

In contrast, this embodiment enables the operator to easily identify the location of an event that has occurred in some unit without moving to the operation section 104 or the operation section 290 by turning on the LED 216 of the unit. By changing the color or pattern of lighting according to the type of the event occurred, the operator can identity the type of the event without moving to the operation section 104 or the operation section 290. This enables the operator to easily find out the event using the LED 216, improving the operability and convenience of the apparatus.

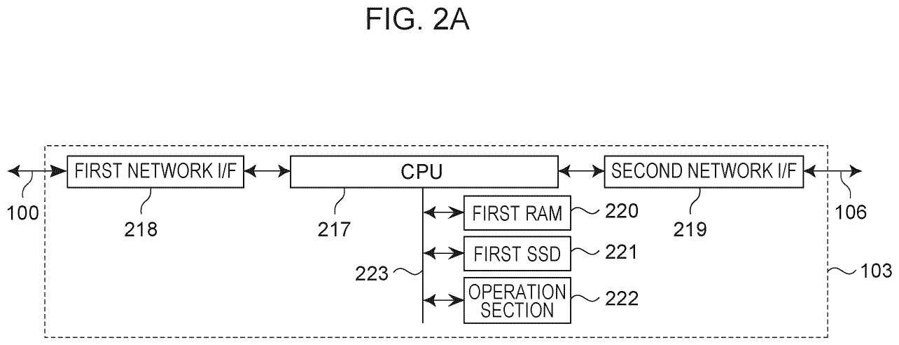

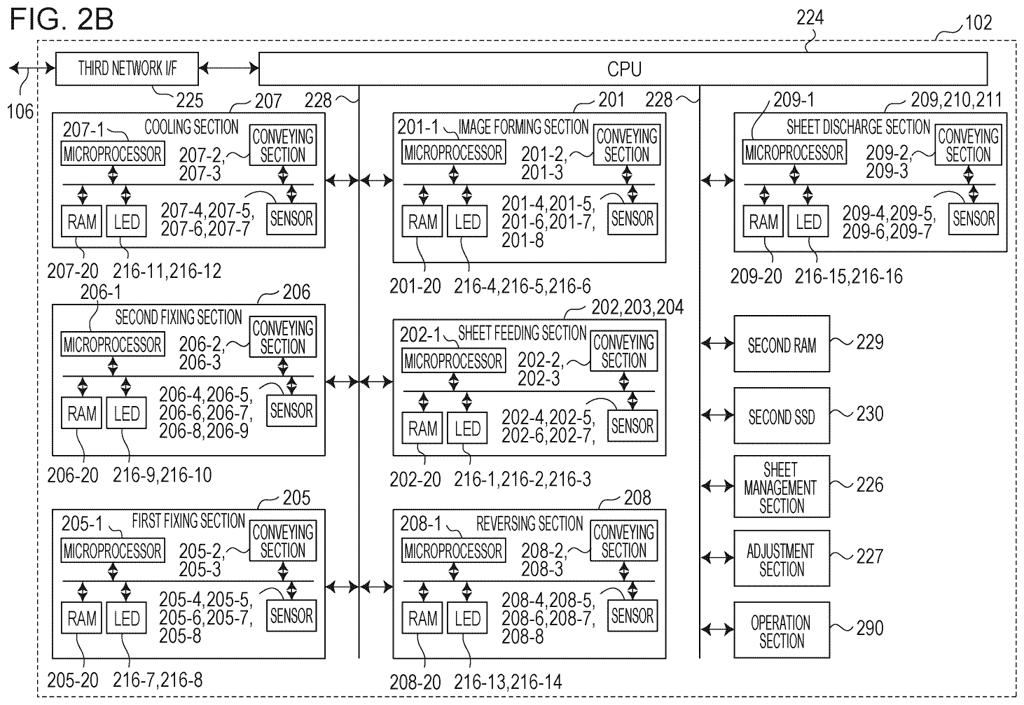

FIGS. 2A and 2B are functional block diagrams illustrating the internal configuration of the image forming apparatus 101 according to the first embodiment. The blocks shown in FIGS. 2A and 2B are divided in units of systems and therefore include blocks that are not necessarily correspond to the units of the apparatus configuration shown in FIG. 1. The internal configuration of each of the DFE 103 and the printer 102 constituting the image forming apparatus 101 will be described hereinbelow with reference to the block diagrams.

FIG. 2A is a functional block diagram illustrating the internal configuration of the DFE 103. A central processing unit (CPU) 217 of the DFE 103 controls the DFE 103 as a whole by reading various programs stored in a first solid state drive (SSD) 221 into a first random-access memory (RAM) 220 and executing them.

A first network interface (I/F) 218 is used to receive print data sent from an information processing apparatus such as the PC 105 connected to the first network 100. The first network I/F 218 is also used to send the status of the image forming apparatus 101 to an information processing apparatus such as the PC 105. The print data received via the first network I/F 218 is processed by the CPU 217. Specific examples of the process include application of print data, a raster image processor (RIP) process, an image conversion process, and a color conversion process. The DFE 103 includes an operation section 222 in addition to the operation section 104. Various settings for the DFE 103, job settings, an instruction to adjust the image forming apparatus 101, and so on are performed by the operator via the operation section 222. The CPU 217 and the individual modules are connected via a system bus 223. The operation section 222 may be omitted, and operations that can be performed by the operation section 222 may be performed by the operation section 104.

The print data processed by the DFE 103 is sent to the printer 102 by a second network I/F 219 via the second network 106.

FIG. 2B is a functional block diagram illustrating the internal configuration of the printer 102. A third network I/F 225 is connected to the second network I/F 219 of the DFE 103 via the second network 106 and mainly receives print data and transmits and receives the status between the DFE 103 and the printer 102 and commands.

The CPU 224 controls the operation of the entire printer 102 as a whole by reading various programs stored in a second SSD 230 into a second RAM 229 and executing them.

Sub-modules 201 to 211 are connected to the CPU 224 via a system bus 228 and operates in response to instructions from the CPU 224. In this embodiment, the CPU 217 of the DFE 103 and the CPU 224 are different. Alternatively, one of the CPUs 217 and 224 may control both of the DFE 103 and the image forming apparatus 101.

A sheet management section 226 stores database constituting a sheet library of the printer 102 and stores the parameters of various media.

An adjustment section 227 is a module that executes various calibrations and controls various sensors. The CPU 224 connects to the first fixing section 205, the second fixing section 206, the cooling section 207, the image forming section 201, the sheet feeding sections 202, 203, and 204, the reversing section 208, and the sheet discharge sections 209, 210, and 211, in addition to the above sections, via the system bus 228.

The internal configuration of the cooling section 207 will be described. A microprocessor 207-1 is configured to control the subunits of the cooling section 207 and provide notifications of control commands and statuses to the CPU 224. An upper conveying section 207-2 and a lower conveying section 207-3 are sheet conveying units provided in the cooling section 207. The conveying processes performed by these units are controlled by the microprocessor 207-1. While multiple reference signs are provided in one block for descriptive purposes, each reference sign corresponds to a single unit. For sensors and LEDs other than the conveying units as well, each reference sign corresponds to a single unit. An upper sheet-passage sensor 207-4 and a lower sheet-passage sensor 207-5 are provided for the upper conveying section 207-2 and the lower conveying section 207-3, respectively, and are used to determine whether a sheet has passed. The upper sheet-passage sensor 207-4 and the lower sheet-passage sensor 207-5 are mainly used to detect a jam that has occurred in the conveying section in the cooling section 207. An upper open/close sensor 207-6 and a lower open/close sensor 207-7 are used to detect the open-close status of doors disposed at the front of the cooling section 207.

LEDs 216-11 and 216-12 are notification units provided in the cooling section 207.

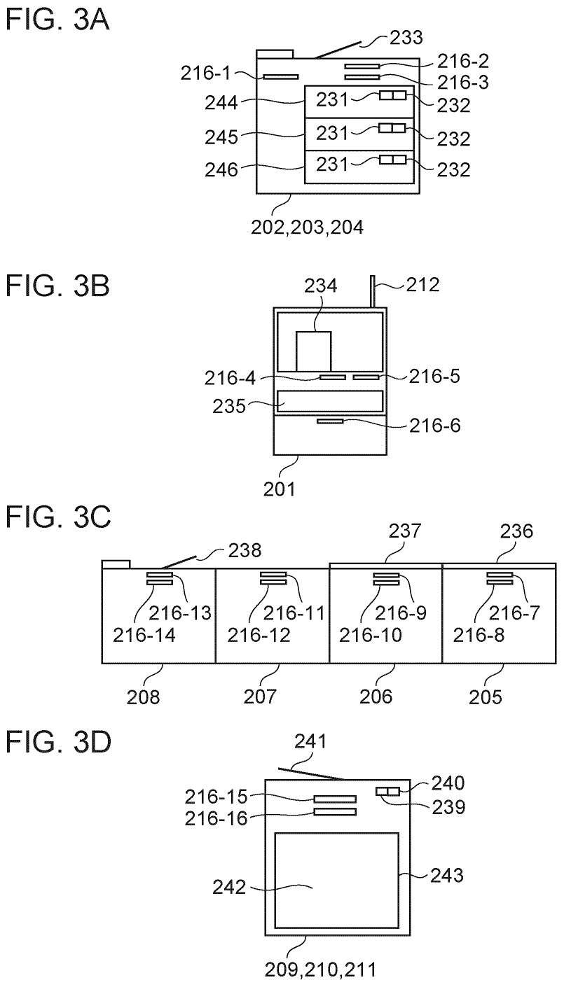

The LEDs 216-11 and 216-12 are used to indicate the location and details of an event that has occurred in the cooling section 207 using the position and color of the LEDs 216-11 and 216-12. The details of which of the LEDs 216-11 and 216-12 lights up in what color when what event has occurred will be described with reference to FIGS. 3A to 3D.

Next, the internal configuration of the first fixing section 205 will be described. A microprocessor 205-1 is configured to control the subunits of the first fixing section 205 and provide notifications of control command and statuses to the CPU 224. An upper conveying section 205-2 and a lower conveying section 205-3 are sheet conveying units provided in the first fixing section 205. The conveying processes performed by these units are controlled by the microprocessor 205-1. An upper sheet-passage sensor 205-4 and a lower sheet-passage sensor 205-5 are provided for the upper conveying section 205-2 and the lower conveying section 205-3, respectively, and are used to determine whether a sheet has passed. The upper sheet-passage sensor 205-4 and the lower sheet-passage sensor 205-5 are mainly used to detect a jam that has occurred in the conveying section in the first fixing section 205. An upper open/close sensor 205-6, a lower open/close sensor 205-7, and a top-cover open/close sensor 205-8 are used to detect the open-close status of doors disposed at the front and top of the first fixing section 205, respectively.

LEDs 216-7 and 216-8 are notification units provided in the first fixing section 205.

The LEDs 216-7 and 216-8 are used to indicate the location and details of an event that has occurred in the first fixing section 205 using the position and color of the LEDs 216-7 and 216-8. The details of which of the LEDs 216-7 and 216-8 lights up in what color when what event occurred will be described later.

Next, the internal configuration of the second fixing section 206 will be described. A microprocessor 206-1 is configured to control the subunits of the second fixing section 206 and provide notifications of control command and statuses to the CPU 224. An upper conveying section 206-2 and a lower conveying section 206-3 are sheet conveying units provided in the second fixing section 206. The conveying processes performed by these units are controlled by the microprocessor 206-1. An upper sheet-passage sensor 206-4 and a lower sheet-passage sensor 206-5 are provided for the upper conveying section 206-2 and the lower conveying section 206-3, respectively, and are used to determine whether a sheet has passed. The upper sheet-passage sensor 206-4 and the lower sheet-passage sensor 206-5 are mainly used to detect a jam that has occurred in the conveying section in the second fixing section 206. An upper open/close sensor 206-6, a lower open/close sensor 206-7, and a top-cover open/close sensor 206-8 are used to detect the open-close status of doors disposed at the front and top of the second fixing section 206, respectively.

LEDs 216-9 and 216-10 are notification units provided in the second fixing section 206. The LEDs 216-9 and 216-10 are used to indicate the location and details of an event that has occurred in the second fixing section 206 using the position and color of the LEDs 216-9 and 216-10. The details of which of the LEDs 216-9 and 216-10 lights up in what color when what event occurred will be described later.

Next, the internal configuration of the image forming section 201 will be described. A microprocessor 201-1 is configured to control the subunits of the image forming section 201 and provide notifications of control commands and statuses to the CPU 224. An upper conveying section 201-2 and a lower conveying section 201-3 are sheet conveying units provided in the image forming section 201. The conveying processes performed by these units are controlled by the microprocessor 201-1. An upper sheet-passage sensor 201-4 and a lower sheet-passage sensor 201-5 are provided for the upper conveying section 201-2 and the lower conveying section 201-3, respectively, and are used to determine whether a sheet has passed. The upper sheet-passage sensor 201-4 and the lower sheet-passage sensor 201-5 are mainly used to detect a jam that has occurred in the conveying section in the image forming section 201. An upper open/close sensor 201-6 and a lower open/close sensor 201-7 are used to detect the open-close status of doors disposed at the front of the image forming section 201.

LEDs 216-4, 216-5, and 216-6 are notification units provided in the image forming section 201. The LEDs 216-4, 216-5, and 216-6 are used to indicate the location and details of an event that has occurred in the image forming section 201 using the position and color of the LEDs 216-4, 216-5, and 216-6. The details of which of the LEDs 216-4, 216-5, and 216-6 lights up in what color when what event occurred will be described later.

Next, the internal configuration of the sheet feeding section (202, 203, 204) will be described. A microprocessor 202-1 is configured to control the subunits of the sheet feeding section (202, 203, 204) and to provide notifications of control command and statuses to the CPU 224.

An upper conveying section 202-2 and a lower conveying section 202-3 are sheet conveying units provided in the sheet feeding section (202, 203, 204). The conveying processes performed by these units are controlled by the microprocessor 202-1. An upper sheet-passage sensor 202-4 and a lower sheet-passage sensor 202-5 are provided for the upper conveying section 202-2 and the lower conveying section 202-3, respectively, and are used to determine whether a sheet has passed. The upper sheet-passage sensor 202-4 and the lower sheet-passage sensor 202-5 are mainly used to detect a jam that has occurred in the conveying section in the sheet feeding section (202, 203, 204). An upper open/close sensor 202-6 and a lower open/close sensor 202-7 are used to detect the open-close status of doors disposed at the front of the sheet feeding section (202, 203, 204).

LEDs 216-1, 216-2, and 216-3 are notification units provided in the sheet feeding section (202, 203, 204). The LEDs 216-1, 216-2, and 216-3 are used to indicate the location and details of an event that has occurred in the sheet feeding section (202, 203, 204) using the position and color of the LEDs 216-1, 216-2, and 216-3. The details of which of the LEDs 216-1, 216-2, and 216-3 lights up in what color when what event occurred will be described later.

Next, the internal configuration of the reversing section 208 will be described. A microprocessor 208-1 is configured to control the subunits of the reversing section 208 and provide notifications of control commands and statuses to the CPU 224. An upper conveying section 208-2 and a lower conveying section 208-3 are sheet conveying units provided in the reversing section 208. The conveying processes performed by these units are controlled by the microprocessor 208-1. An upper sheet-passage sensor 208-4 and a lower sheet-passage sensor 208-5 are provided for the upper conveying section 208-2 and the lower conveying section 208-3, respectively, and are used to determine whether a sheet has passed. The upper sheet-passage sensor 208-4 and the lower sheet-passage sensor 208-5 are mainly used to detect a jam that has occurred in the conveying section in the reversing section 208. An upper open/close sensor 208-6 and a lower open/close sensor 208-7 are used to detect the open-close status of doors disposed at the front of the reversing section 208.

LEDs 216-13 and 216-14 are notification units provided in the reversing section 208.

The LEDs 216-13 and 216-14 are used to indicate the location and details of an event that has occurred in the reversing section 208 using the position and color of the LEDs 216-13 and 216-14. The details of which of the LEDs 216-13 and 216-14 lights up in what color when what event occurred will be described later.

Next, the internal configuration of the sheet discharge sections 209, 210, and 211 will be described. A microprocessor 209-1 is configured to control the subunits of the sheet discharge sections 209, 210, and 211 and provide notifications of control commands and statuses to the CPU 224.

An upper conveying section 209-2 and a lower conveying section 209-3 are sheet conveying units provided in each of the sheet discharge sections 209, 210, and 211. The conveying processes performed by these units are controlled by the microprocessor 209-1. An upper sheet-passage sensor 209-4 and a lower sheet-passage sensor 209-5 are provided for the upper conveying section 209-2 and the lower conveying section 209-3, respectively, and are used to determine whether a sheet has passed. The upper sheet-passage sensor 209-4 and the lower sheet-passage sensor 209-5 are mainly used to detect a jam that has occurred in the conveying section in the sheet discharge sections 209, 210, and 211. An upper open/close sensor 209-6 and a lower open/close sensor 209-7 are used to detect the open-close status of doors disposed at the front of the sheet discharge sections 209, 210, and 211.

LEDs 216-15 and 216-16 are notification units provided in each of the sheet discharge sections 209, 210, and 211. The LEDs 216-15 and 216-16 are used to indicate the location and details of an event that has occurred in the sheet discharge sections 209, 210, and 211 using the position and color of the LEDs 216-15 and 216-16. The details of which of the LEDs 216-15 and 216-16 lights up in what color when what event occurred will be described later.

The conveying paths (sheet conveying paths) of the modules described above each have a door (cover) at the front or the top and are housed inside. For this reason, when a jam occurs during execution of a printing process, and maintenance, such as removing the paper jammed on the conveying path, is performed, the operator has to open the door (cover) to access the conveying path. After completion of necessary maintenance, the operator has to close the door (cover) into the initial state. In other words, the operator detects the completion of the jam clearance process for the printer 102 from the change in the open-close state of the door (cover) and executes a subsequent clearance process internally. The open/close sensors of the modules are used to detect the door (cover) open/close operation associated with the maintenance performed by the operator, described above.

The modules include corresponding RAMs 201-20 to 209-20 for storing programs, data, and processing results that are used when the microprocessors 201-1 to 209-1 execute processes. Alternatively, the microprocessors 201-1 to 209-1 may access the second RAM 229 via the system bus 228 to implement equivalent processes.

The operation section 290 is used to perform various operations, such as configuring the printer 102. The operation section 290 of the printer 102 may be replaced with the operation section 222 of the DFE 103.

FIGS. 3A to 3D are diagrams illustrating the details of the configurations of the units of the printer 102.

FIG. 3A is a diagram illustrating the configuration of the sheet feeding section (202, 203, 204). The sheet feeding section (202, 203, 204) according to this embodiment includes three trays 244, 245, and 246 in which sheets of different types and sizes can be stored. The trays 244, 245, and 246 each include a tray-open instruction unit 231 and a remaining-amount display unit 232 for the sheets stored therein. An escape tray 233 is used to discharge bent sheets or double fed sheets, which can cause problems, to prevent them from being conveyed to the image forming section 201.

The sheet feeding section (202, 203, 204) includes three LEDs 216-1, 216-2, and 216-3.

The LED 216-1 is a unit for notifying the operator of the occurrence of a sheet jam in the lower conveying section 202-3 in the sheet feeding section (202, 203, 204) by lighting in red. The sheet jam is also simply referred to as a jam.

The LED 216-2 is a unit for providing a notification by lighting in red when a jam occurs in the upper conveying section 202-2 within the sheet feeding section 202, 203, or 204. The LED 216-2 is also used to indicate information different from a jam. Specifically, in the system of this embodiment, the LED 216-2 are also used to provide information by lighting in red when the sheets discharged onto the escape tray 233 become full. Furthermore, also when the escape tray becomes nearly full, the LED 216-2 lights in yellow to present the information.

The LED 216-3 is provided to present the remaining sheet quantity in the trays 244, 245, and 246 of the sheet feeding section (202, 203, 204).

FIG. 3B is a diagram for illustrating the configuration of the image forming section 201. Since the notification unit 212 is described with reference to FIG. 1, the details are omitted. The image forming section 201 includes a print head unit 234 including ink-jet heads and a control unit in the center. An ink-tank control unit 235 includes an information presentation section for indicating an ink supply process, a waste ink replacing process, and the amounts of supply ink and waste ink.

The LEDs 216-4 and 216-5 are units for notifying the operator of the occurrence of a jam in the upper conveying section 201-2 within the image forming section 201 by lighting in red. The LED 216-6 is used to notify the operator of the occurrence of a jam in the lower conveying section 201-3 within the image forming section 201 by lighting in red.

FIG. 3C is a diagram for illustrating the configuration of the first fixing section 205, the second fixing section 206, the cooling section 207, and the reversing section 208. The reversing section 208 of this embodiment includes an escape tray 238 for discharging sheets that are retained in the printer 201, for example, in the event of an error in the printer 201. The first fixing section 205 and the second fixing section 206 have covers 236 and 237 on the top, respectively. This is provided to prevent the operator or maintenance personnel from accidentally touching the heater, because the first fixing section 205 and the second fixing section 206 use the heater to dry the sheets.

The LED 216-7 is a unit for notifying the operator of the occurrence of a jam in the upper conveying section 205-2 within the first fixing section 205 by lighting in red. The LED 216-8 is a unit for notifying the operator of the occurrence of a jam in the lower conveying section 205-3 within the first fixing section 205 by lighting in red.

The LED 216-9 is a unit for notifying the operator of the occurrence of a jam in the upper conveying section 206-2 within the second fixing section 206 by lighting in red. The LED 216-10 is a unit for notifying the operator of the occurrence of a jam in the lower conveying section 206-3 within the second fixing section 206 by lighting in red.

The LED 216-11 is a unit for notifying the operator of the occurrence of a jam in the upper conveying section 207-2 within the cooling section 207 by lighting in red. The LED 216-12 is a unit for notifying the operator of the occurrence of a jam in the lower conveying section 207-3 within the cooling section 207 by lighting in red.

The LED 216-13 is a unit for notifying the operator of the occurrence of a jam in the upper conveying section 208-2 within reversing section 208 by lighting in red. The LED 216-14 is a unit for notifying the operator of the occurrence of a jam in the lower conveying section 208-3 within the reversing section 208 by lighting in red.

FIG. 3D is a diagram for illustrating the configuration of the sheet discharge section (209, 210, 211). The sheet discharge section (209, 210, 211) of this embodiment includes two sheet discharge portions.

A stack unit 242 is used to stack a large volume of sheets and is protected by a door 243. A sample tray 241 is used to discharge a small volume of sheets and does not include a door or the like. The stack unit 242 has a jogger mechanism (not shown) inside to improve the sheet stacking performance. In a configuration including multiple sheet discharge sections 209, 210, and 211 as in FIG. 1, the printer 102 of this embodiment has a feature called “tray linking”, which enables multiple stack units to be treated as a signal discharge destination.

A tray-eject instruction unit 239 is used when the stacked sheets are discharged by releasing the door 243 to enable the stack unit to be accessed. A tray-stack-amount notification unit 240 is a display unit for notifying the operator of the volume (height) of stacked sheets using a stepwise indication.

An LED 216-15 is a unit for notifying the operator of the occurrence of a jam in the upper conveying section 209-2 within the sheet discharge section (209, 210, 211) by lighting in red. The system according to this embodiment is also used when the LED 216-15 notifies the operator by lighting in red that the sheets stacked on the sample tray 241 of the sheet discharge section (209, 210, 211) are full. The system according to this embodiment is also used when the LED 216-15 notifies the operator by lighting in yellow that the sheets stacked on the sample tray 241 of the sheet discharge section (209, 210, 211) are nearly full.

An LED 216-16 is a unit for notifying the operator of the occurrence of a jam in the lower conveying section 209-3 within the sheet discharge section (209, 210, 211) by lighting in red. The system according to this embodiment is also used when the LED 216-16 notifies the operator by lighting in red that the sheets stacked in the stack unit 242 of the sheet discharge section (209, 210, 211) are full. The system according to this embodiment is also used when the LED 216-16 notifies the operator by lighting in yellow that the sheets stacked in the stack unit 242 of the sheet discharge section (209, 210, 211) are nearly full.

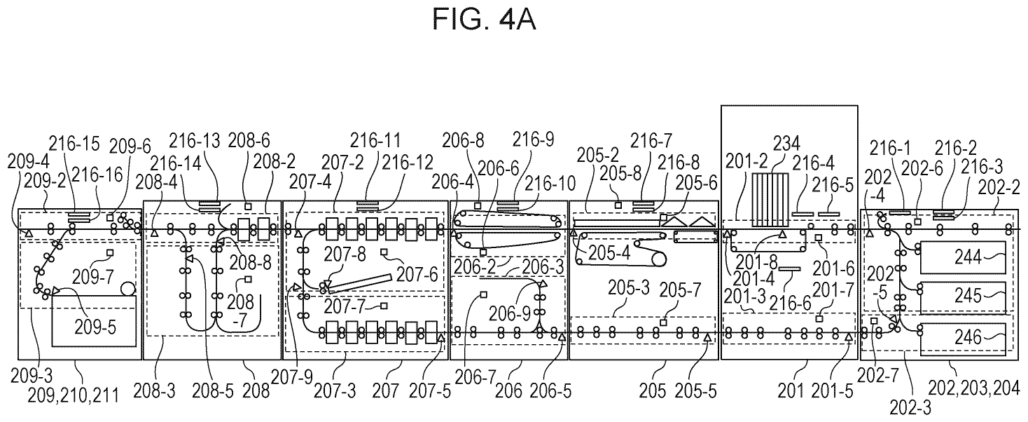

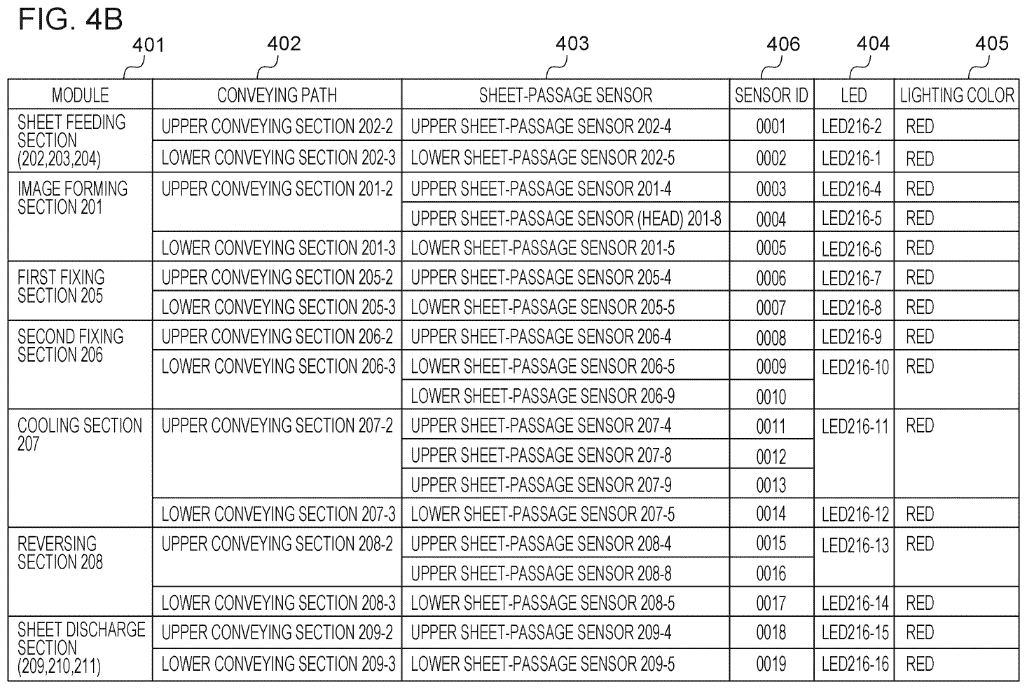

FIG. 4A is a diagram for illustrating the configuration of the conveying paths of the modules of the printer 102, the positional relationship among the sheet-passage sensors, and the positional relationship of the LEDs.

The sheet feeding section (202, 203, 204) will be described. The sheet feeding section (202, 203, 204) includes the upper conveying section 202-2 and the lower conveying section 202-3 arranged as illustrated.

The upper conveying section 202-2 and the lower conveying section 202-3 include sheet-passage sensors 202-4 and 202-5, respectively, downstream thereof. The sheet-passage sensors 202-4 and 202-5 detect passage of a sheet conveyed along the conveying path to determine whether there is a sheet. The sheet-passage sensors 202-4 and 202-5 according to this embodiment are used to detect the occurrence of a jam.

Specifically, the jam is detected using the following method. In other words, sheets are conveyed by the upper conveying section 202-2 and the lower conveying section 202-3 under the control of the microprocessor of each module including the sheet feeding sections 202, 203, and 204 according to an instruction from the CPU 224.

Sheets are conveyed to the module, where the sheets are conveyed and discharged from the module by controlling the conveying section provided in the module. In this case, the time taken for the sheets conveyed into the module to be discharged from the module is assumed to be an in-module retained time from the relationship among the sheet conveying speed and the shape and length of the conveying path in the module. If sheets are detected by the sheet-passage sensors during the elapse of the in-module retention time, it can be determined that the conveying process has been carried out as assumed. However, if no sheets are detected by the sheet-passage sensors as assumed although the assumed in-module retention time has elapsed, it can be determined that the sheets are not properly conveyed, and a jam may have occurred in the vicinity of the sensors.

In other words, the CPU 224 can detect that a sheet jam has occurred between sheet-passage sensors based on the fact that, after a sheet is detected by one sheet-passage sensor, the next sheet-passage sensor fails to detect the sheet within a predetermined time.

If one sheet-passage sensor continues to detect sheets beyond the normal time period from when the sensor first detects the sheet until the sensor detects no sheet, it can be determined that the sheet may not be properly conveyed, and a jam may have occurred in the vicinity of the sensor.

When a sheet is detected by one sheet-passage sensor at a timing other than the assumed timing as well, it can likewise be determined that the conveying process is not being executed under proper control, and therefore, it can be concluded that a jam has occurred.

When a jam is detected in the lower conveying section 202-3 (FIG. 4A), the LED 216-1 lights up in red to indicate the jam. If a jam is detected in the upper conveying section 202-2, the LED 216-2 lights up in red to indicate the jam.

The image forming section 201 will be described. The image forming section 201 includes an upper conveying section 201-2 and a lower conveying section 201-3, which are arranged as illustrated. The upper conveying section 201-2 includes sheet-passage sensors 201-4 and 201-8 in its downstream portions, and the lower conveying section 201-3 includes a sheet-passage sensor 201-5 in its downstream portion. When a jam is detected in the upper conveying section 202-2 (FIG. 4A), the LED 216-4 or 216-5 lights up in red to indicate the jam. When a jam is detected in the lower conveying section 201-2, the LED 216-6 lights up in red to indicate the jam. Since a method for detecting the jam is the same as the method for the sheet feeding sections 202, 203, and 204, the details are omitted.

The first fixing section 205 will be described. The first fixing section 205 includes an upper conveying section 205-2 and a lower conveying section 205-3, which are arranged as illustrated. The upper conveying section 205-2 and the lower conveying section 205-3 include sheet-passage sensors 205-4 and 205-5, respectively, in their downstream portions. When a jam is detected in the upper conveying section 205-2 (FIG. 4A), the LED 216-7 lights up in red to indicate the jam. When a jam is detected in the lower conveying section 205-3, the LED 216-8 lights up in red to indicate the jam. Since a method for detecting the jam is the same as the method for the sheet feeding sections 202, 203, and 204, the details are omitted.

The second fixing section 206 will be described. The first fixing section 206 includes an upper conveying section 206-2 and a lower conveying section 206-3, which are arranged as illustrated. The upper conveying section 206-2 includes a sheet-passage sensor 206-4 in its downstream portion, and the lower conveying section 206-3 includes sheet-passage sensors 206-5 and 206-9 in its downstream portions. When a jam is detected in the upper conveying section 206-2 (FIG. 4A), the LED 216-9 lights up in red to indicate the jam. When a jam is detected in the lower conveying section 206-3, the LED 216-10 lights up in red to indicate the jam. Since a method for detecting the jam is the same as the method for the sheet feeding sections 202, 203, and 204, the details are omitted.

The cooling section 207 will be described. The cooling section 207 includes an upper conveying section 207-2 and a lower conveying section 207-3, which are arranged as illustrated. The upper conveying section 207-2 includes sheet-passage sensors 207-4, 207-8, and 207-9 in its downstream portions, and the lower conveying section 207-3 includes a sheet-passage sensor 207-5 in its downstream portion. When a jam is detected in the upper conveying section 207-2 (FIG. 4A), the LED 216-11 lights up in red to indicate the jam. When a jam is detected in the lower conveying section 207-3, the LED 216-12 lights up in red to indicate the jam. Since a method for detecting the jam is the same as the method for the sheet feeding sections 202, 203, and 204, the details are omitted.

The reversing section 208 will be described. The reversing section 208 includes an upper conveying section 208-2 and a lower conveying section 208-3, which are arranged as illustrated. The upper conveying section 208-2 includes a sheet-passage sensor 208-4 in its downstream portions, and the lower conveying section 208-3 includes sheet-passage sensors 208-5 and 208-8 in its downstream portions. When a jam is detected in the upper conveying section 208-2 (FIG. 4A), the LED 216-13 lights up in red to indicate the jam. When a jam is detected in the lower conveying section 208-3, the LED 216-14 lights up in red to indicate the jam. Since a method for detecting the jam is the same as the method for the sheet feeding sections 202, 203, and 204, the details are omitted.

The sheet discharge section (209, 210, 211) will be described. The sheet discharge section (209, 210, 211) includes the upper conveying section 209-2 and the lower conveying section 209-3 arranged as illustrated.

The upper conveying section 209-2 and the lower conveying section 209-3 include sheet-passage sensors 209-4 and 209-5, respectively, downstream thereof. When a jam is detected in the upper conveying section 209-2 (FIG. 4A), the LED 216-15 lights up in red to indicate the jam. When a jam is detected in the lower conveying section 209-3, the LED 216-16 lights up in red to indicate the jam. Since a method for detecting the jam is the same as the method for the sheet feeding sections 202, 203, and 204, the details are omitted.

In FIG. 4A, the number of sheet-passage sensors disposed along the conveying path of each module is limited for illustrative purposes. However, any multiple numbers of sheet-passage sensors may be disposed along the conveying path as necessary.

FIG. 4B is a table showing the relationship between the portion where a jam has occurred and an LED that lights up at that time for each module illustrated in FIGS. 3A to 3D and FIG. 4A. As illustrated, the correspondence relationship among the conveying path 402, the sheet-passage sensor 403, the LED 404, and the lighting color 405 of each module 401 illustrated in FIG. 2B, FIGS. 3A to 3D, and FIG. 4A can be determined. The CPU 224 and the microprocessors 201-1 to 209-1 control the LEDs according to the relationship shown in FIG. 4B. FIG. 4B also shows information on sensor ID 406. The sensor ID 406 is referred to and used in executing the operation of the flowchart described below. The table shown in FIG. 4B is stored in a second SSD 230, from which the CPU 224 can read the table for processing.

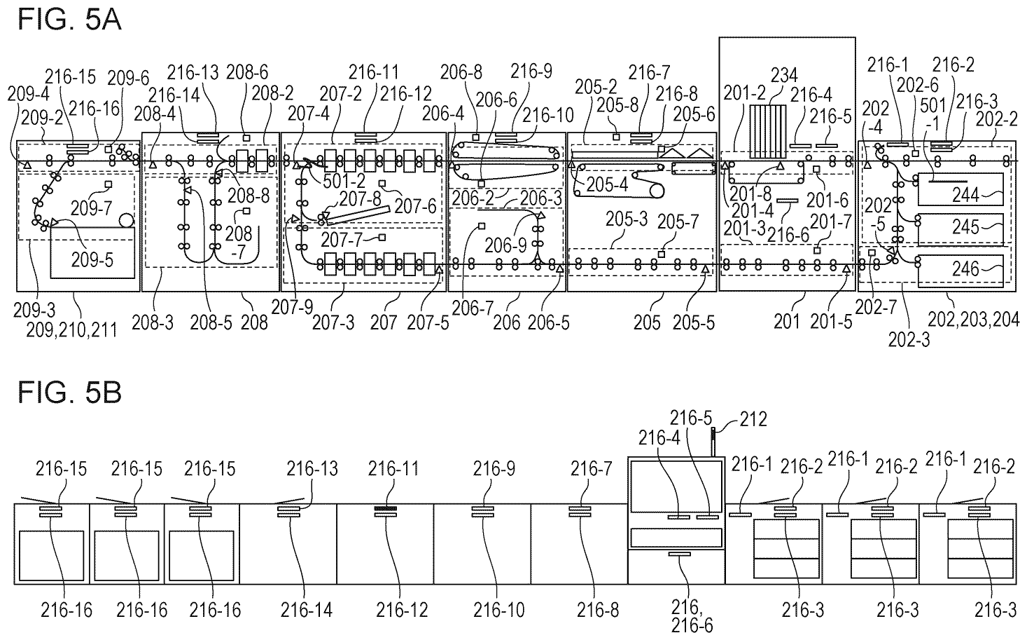

Referring next to FIG. 5A, an example will be described in which, when a jam occurs in the image forming apparatus 101 of this embodiment, the LED 216 indicates the module at which the jam has occurred, the location of the jam in the module, and the kind of the generated event.

In one example, the following description uses a single-sided printing job as a print job setting in which sheets are fed from the tray 244 in the sheet feeding section 202 and output to the stack unit 242 in the sheet discharge section 209.

In the example of the print job described above, with the device configuration of the printer 101 and the disposition of the conveying sections shown in FIG. 4A, the printing process is executed on the sheet placed on the tray 244.

To stack the sheets in the stack unit 242, the printer 101 conveys the sheets through the conveying sections and the print head 234 in the following order. In this case, if the print job is properly executed, the proper sheet-passage state is detected by the sheet-passage sensors placed on the conveying section of each unit. Specifically, the sheets pass through as follows:
Sheet feeding section 202: Upper conveying section 202-2
Image forming section 201: Upper conveying section 201-2
Image forming section 201: Print head unit 234
First fixing section 205: Upper conveying section 205-2
Second fixing section 206: Upper conveying section 206-2
cooling section 207: Upper conveying section 207-2
Reversing section 208: Upper conveying section 208-2
sheet discharge section 209: Upper conveying section 209-2
Sheet discharge section 209: Lower conveying section 209-3
Sheet discharge section 209: Stack unit 242

However, assume that a jam occurs in any of the conveying sections along the conveying path. In one example, the following description assumes a scenario with reference to FIGS. 5A and 5B where a sheet 501-1 fed from the tray 244 caused a jam halfway through the upper conveying section 207-2 in the cooling section 207, and the jammed sheet 501-1 stopped in the upper conveying section 207-2.

In one example, the following description assumes a scenario where the sheet 501-1 has passed through the aforementioned conveying path and reached the inlet of the upper conveying section 207-2 in the cooling section 207.

The sheet 501-1 conveyed to the upper conveying section 207-2 in the cooling section 207 is conveyed downstream at a conveying speed determined by the system to reach the sheet-passage sensor 207-4, where the sheet 501-1 is detected. In a normal state, the sheet 501-1 passes through the sensor 207-4 after a predetermined time required to convey the sheet 501-1 passes, and the sheet detection state is completed.

However, assume that a sheet jam occurs in the vicinity of the sheet-passage sensor 207-4, and the conveying process stops. In other words, the sheet remains near the sheet-passage sensor 207-4 on the conveying path, and the sheet 501-1 is continuously detected by the sensor 207-4, if in a normal state, even after the detection time ends with a lapse of the conveyance of the sheet 501-1. Thus, the system of this embodiment is configured to detect a jam when a single sheet-passage sensor continues to detect a sheet for a specified time or more.

Similarly, assume that the sheet 501-1 is detected by the sheet-passage sensor 207-4 at a time other than the predetermined required time. In this case, the sheet may fall out of a proper state under conveyance control. Thus, the system of this embodiment is configured to detect a jam when the sheet 501-1 is detected by the sheet-passage sensor 207-4 in such a situation.

However, various other methods for detecting the occurrence of a jam and the location of the jam are known in addition to the method shown in FIGS. 5A and 5B. It will be appreciated that the method shown in FIGS. 5A and 5B is illustrative only and any other methods are applicable to the present invention.

The example illustrated in FIGS. 5A and 5B is of a case in which a single sheet is fed and enters a jam state. However, it goes without saying that the above description is also applied to each of multiple sheets that are continuously fed.

FIG. 5B illustrates a state in FIG. 5A, presented as an example, in which the printer 101 is performing a printing process, that is, a state in which the sheet 501-1 is stopped in a jammed state (501-2) in the upper conveying section 207-2 in the cooling section 207. The lighting state of the LEDs 216 of the image forming apparatus 101 will be described with reference to FIG. 5B.

FIG. 5B illustrates the LED 216-11 of the cooling section 207 lights up in red. This enables the operator to be notified of the occurrence of a jam in the upper conveying section 207-2 of the cooling section 207 by the lighting state of the LED 216-11.

In other words, in a related-art system, if a jam occurs and is detected in an apparatus, the notification unit 212 or the operation section 104 presents the information on the event. However, the notification unit 212 can present the information on the occurrence of the event in a manner that enables the operator to confirm the event from a location separate from the apparatus, but cannot present the information in a manner that enables the operator to identify at which location in which module the jam has occurred.

In contrast, the operation section 104 includes a display unit suitable for presenting complicated information and can therefore present the occurrence of an event, a module where the event has occurred, the information on its internal site. However, the operator has to move to the operation section 104 to obtain the information. In other words, the operator cannot obtain the information from a location separate from the apparatus.

In contrast, the method according to an embodiment of the present invention enables the operator to identify the lighting of the LED in the module even from a location separate from the apparatus, as described above. This enables the operator to find the occurrence of an event, the module where the event has occurred, and the information on the location of the event in the module.

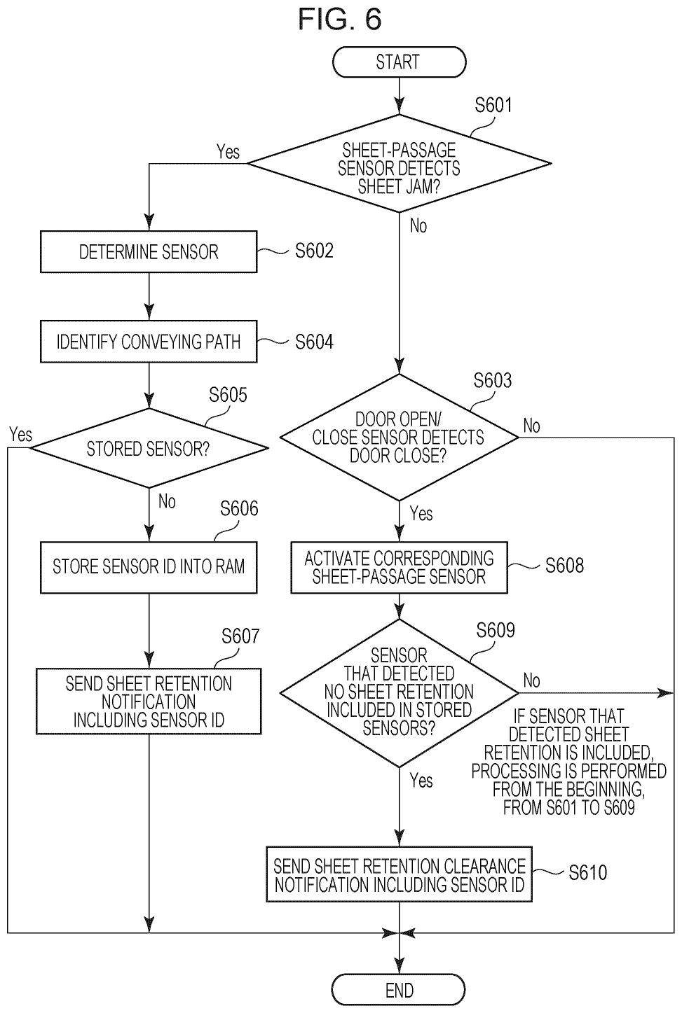

FIG. 6 is a flowchart illustrating a printing process according to an embodiment of the present invention, in particular, an LED control operation when a jam occurs. The CPU 224 reads various programs stored in the second SSD 221 into the second RAM 220 and executes them. The CPU 224 sends instructions to the respective microprocessors of the modules 201 to 211 connected to the system bus 228. The microprocessors execute processes in response to the instructions from the CPU 224. Alternatively, the CPU 224 may directly control the sensors, conveying sections, the LEDs, and so on without using microprocessors.

Here, the processing procedure of the microprocessors 201-1 to 209-1 that have received notifications from the sensors of the modules 201 to 211 will be described in detail with reference to FIG. 6.

The processing of FIG. 6 is started when a notification is received from any of the sensors. FIG. 6 focuses on the image forming section 201. However, since there is no difference in operation among the modules, the same processing as shown in FIG. 6 is also executed in the other modules 202 to 209.

In step S601, the microprocessor 201-1 determines whether a sheet retention (jam) was detected by the sheet-passage sensor 201-4 or 201-5. Specifically, if a single sheet-passage sensor continues to detect a sheet for a predetermined time or more or detects a sheet at a timing different from a predetermined arrival timing, the microprocessor 201-1 determines that a sheet jam was detected. The upper sheet-passage sensors 201-4 and 201-8 and the lower sheet-passage sensor 201-5 are each assigned a unique sensor ID, as shown in FIG. 4B. If a sheet jam is detected, the process proceeds to step S602; otherwise, the process proceeds to step S603.

In step S602, the microprocessor 201-1 determines the ID of the sensor that provided the notification in step S601. Specifically, the microprocessor 201-1 determines which of the sensors in the ID 406 of FIG. 4B provided the notification.

In step S604, the microprocessor 201-1 identifies a conveying path to which the sensor identified by the ID determined in step S602 belongs. Specifically, the microprocessor 201-1 identifies the conveying path 402 associated by the ID 406 in the table shown in FIG. 4B.

In step S605, the microprocessor 201-1 determines whether the sheet-passage sensor (201-4, 201-5, 201-8) that detected sheet retention, determined in steps S602 and S604, is the stored sensor. The microprocessor 201-1 determines it depending on whether the ID of the sensor that detected the sheet retention matches the ID of the stored sensor. If the sheet-passage sensor that detected the sheet retention is the stored sensor, the processing is completed; otherwise, the process proceeds to step S606.

In step S606, the microprocessor 201-1 stores the ID determined in step S602 into the RAM 201-20, and in step S607, the microprocessor 201-1 sends a sheet retention notification to the CPU 224. The sheet retention notification includes the sensor ID stored in step S606 and the information on the conveying path in which the jam occurred, identified in step S604. After the sheet retention notification is sent, the processing is terminated.

In step S603, the microprocessor 201-1 determines whether the open/close sensor (201-6, 201-7) detected door close. Each module includes an upper door for accessing the portion where the upper sheet-passage sensors 201-4 and 201-8 are disposed and a lower door for accessing the portion where the lower sheet-passage sensor 201-5 is disposed, to which an upper open/close sensor 201-6 and a lower open/close sensor 201-7 are mounted, respectively. The doors and the door open/close sensors 201-6 and 201-7 are also each assigned a unique ID.

If the open/close sensors 201-6 or 201-7 detects door close, the process proceeds to step S608; otherwise, the processing is terminated.

In step S608, the microprocessor 201-1 activates the sheet-passage sensor 201-4, 201-5, or 201-8 at a position accessible from the door where the open/close sensor 201-6 or 201-7 that detected door close is disposed. In other words, in the case of the upper door, the upper sheet-passage sensors 201-4 and 201-8 are activated, and in the case of the lower door, the lower sheet-passage sensor 201-5 is activated. After the activation, the process proceeds to step S609.

In step S609, the microprocessor 201-1 determines whether the sheet-passage sensor 201-4, 201-5, or 201-8 that detected no sheet retention is included in the stored sensors.

The storage of the sensor ID is performed in step S606. The determination is performed based on whether the ID of the sensor that detected no sheet retention matches the stored sensor IDs. If there is a sensor that detected no sheet retention, the process proceeds to step S610; otherwise, the processing shown in FIG. 6 is terminated.

In step S610, the microprocessor 201-1 sends a sheet retention clearance notification to the CPU 224. The sheet retention clearance notification includes the ID of the sensor determined not to have detected sheet retention in step S609. After the sheet retention clearance notification is sent, the processing is terminated.

If there is a sensor that detected sheet retention, the processing is performed from the beginning, from step S601 to step S602.

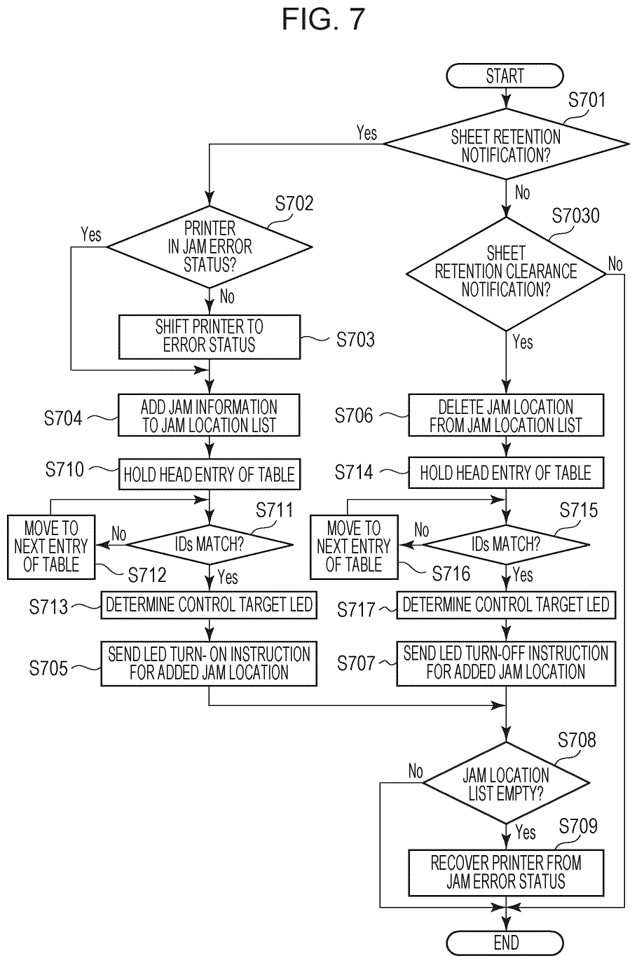

FIG. 7 is a flowchart illustrating processing when the CPU 224 receives a notification from any of the modules 201 to 211. The processing of the flowchart in FIG. 7 is performed by the CPU 224 reading various programs stored in the second SSD 221 into the second RAM 220 and executing them. When the CPU 224 receives a notification from any of the modules 201 to 211, the processing of the flowchart is started. The kind of the notification can be determined using the identifier included in the notification.

In step S701, the CPU 224 determines whether the received notification is a sheet retention notification. If the received notification is a sheet retention notification, the process proceeds to step S702; otherwise, the process proceeds to step S7030.

In step S702, the CPU 224 determines whether the image forming apparatus 101 is in a jam error status. If the image forming apparatus 101 is not in a jam error status, the image forming apparatus 101 shifts to a jam error status because the process shifted to step S702 as a result of the determination of step S701. The process therefore proceeds to step S703, where the image forming apparatus 101 is shifted to a jam error status.

If the result of the determination of step S702 is true, the image forming apparatus 101 has already been in a jam error status. In this case, step S703 is skipped, and the process proceeds to step S704.

In step S704, the CPU 224 adds the jam information obtained in step S701 to the stored list as a new jam location. The stored information includes the ID 406 of the sensor that detected the jam, and the CPU 224 and the microprocessors 201-1 to 209-1 are used as jam location identifiers to determine or identify the jam location.

The processes from step S710 onward configure a loop process for identifying the control target LED associated with the conveying path corresponding to the jam location added in step S704 from the table shown in FIG. 4B.

The CPU 224 performs the subsequent processes in FIG. 7 by reading the table shown in FIG. 4B from the SSD 230. In other words, in step S710, the CPU 224 holds the head entry in the table of FIG. 4B. Specifically, the CPU 224 holds a table entry with a sensor ID of 0001.

In step S711, the CPU 224 determines whether the ID held in step S710 is the same as the ID included in the sheet retention notification received in this processing. Since the sheet retention notification received in this processing is the information sent in step S607 of FIG. 6, it includes the ID of the sheet-passage sensor that has detected a jam.

If the result of the determination in step S711 is false, it indicates that the IDs are mismatched, and therefore the process proceeds to step S712, where the process moves to the next entry of the table shown in FIG. 4B and returns to step S711 for the CPU 224 to determine whether the IDs match through the loop process.

If the result of the determination in step S711 is true, the process proceeds to step S713, where the module and the control-target LED (404) associated with the matched ID in the table shown in FIG. 4B are identified.

In step S705, the CPU 224 sends a lighting instruction to the microprocessor 201-1 to turn on the LED (216-4, 216-5, 216-6) corresponding to the jam location of the conveying path of the module corresponding to the added jam location.

If the result of the determination in step S702 is false, the process proceeds to step S703, where the CPU 224 determines whether the received notification is a sheet retention clearance notification. If the received notification is a sheet retention clearance notification, the process proceeds to step S706; otherwise, the processing of this flowchart is terminated.

In step S706, the jam location corresponding to the sheet retention clearance notification, determined in step S703, is deleted from the jam location list.

The processes from step S714 onward configure a loop process for identifying the control target LED associated with the conveying path corresponding to the jam location deleted in step S706 from the table shown in FIG. 4B.

The CPU 224 performs the subsequent processes in FIG. 7 by reading the table shown in FIG. 4B from the SSD 230. In other words, in step S714, the CPU 224 holds the head entry in the table of FIG. 4B. Specifically, the CPU 224 holds a table entry with a sensor ID of 0001.

In step S715, the CPU 224 determines whether the ID held in step S714 is the same as the ID included in the sheet retention notification received in this processing. Since the sheet retention notification received in this processing is the information sent in step S610 of FIG. 6, it includes the ID of the sheet-passage sensor that has detected a jam clearance.

If the result of the determination in step S715 is false, it indicates that the IDs are mismatched, and therefore the process proceeds to step S716, where the process moves to the next entry of the table shown in FIG. 4B and returns to step S715 for the CPU 224 to determine whether the IDs match through the loop process.

If the result of the determination in step S715 is true, the process proceeds to step S717, where the module and the control-target LED (404) associated with the matched ID in the table shown in FIG. 4B are identified.

In step S707, since the jam is cleared, the CPU 224 sends a turn-off instruction, corresponding to the sheet retention release notification, to the microprocessor 201-1 of the image forming section 201 to turn off the LED (216-4, 216-5, 216-6) that is in a lit state.

In step S708, the CPU 224 checks the jam location list to determine whether the list is empty, that is, whether the jam information has disappeared.

If the result of the determination in step S708 is true, it indicates that the jam statuses of all the conveying paths generated in the image forming apparatus 101 were cleared.

If the result of the determination in step S708 is true, the process proceeds to step S709, where the image forming apparatus 101 is returned to the normal state. If the result of the determination in step S709 is false, it indicates that another error factor remains, and therefore, step S709 is skipped, and the processing of the flowchart is terminated.

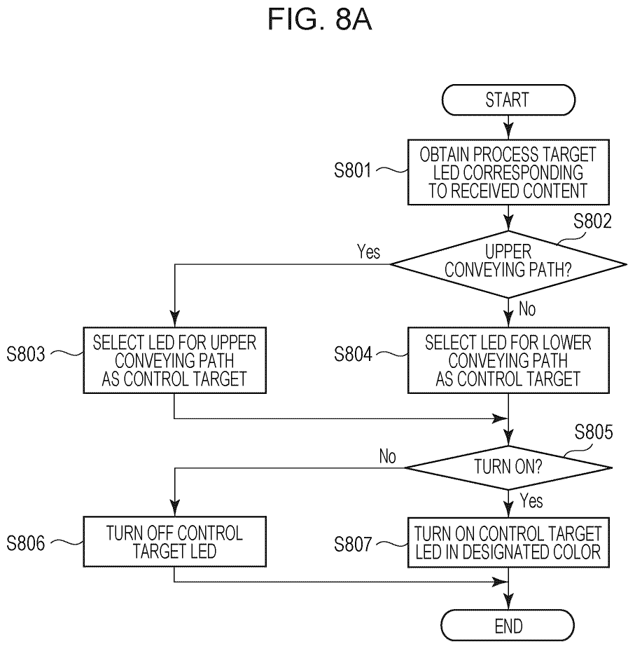

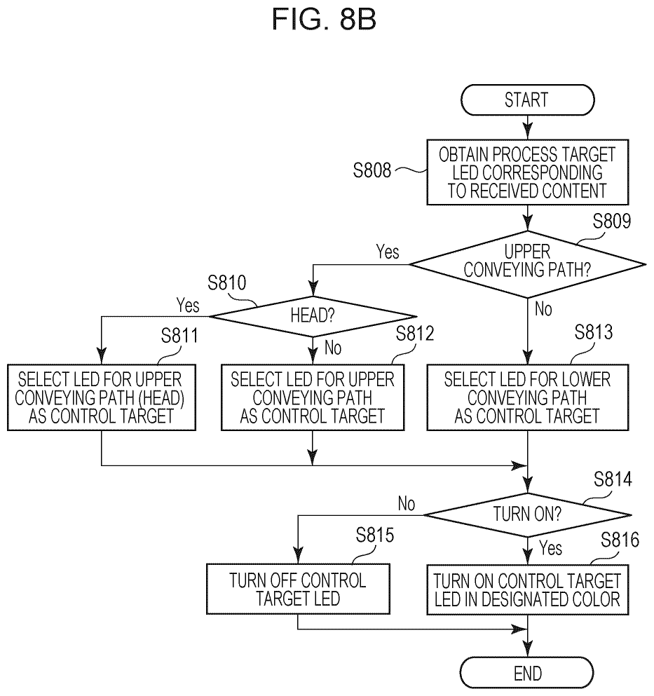

FIG. 8A is a flowchart illustrating the operation when the respective microprocessors 202-1 to 211-1 of the modules 202 to 211 other than the image forming section 201 receive and process an LED-on or LED-off instruction from the CPU 224, illustrated in FIG. 7.

In step S801, the microprocessor (202-1 to 211-1) determines the received instruction content. Specifically, the microprocessor (202-1 to 211-1) analyzes the information included in the instruction, including information on the control target LED, turning-on or turning-off, and lighting color.

In step S802, the microprocessor (202-1 to 211-1) determines whether the jam notification is for the upper conveying path from the LED information included in the information obtained in step S801. If the determination result is true, the process proceeds to step S803, where the microprocessor (202-1 to 211-1) selects an LED for the upper conveying path of the module that has received the instruction as the control target LED. Since the LED for the upper conveying path of each module is illustrated in FIG. 5B, the details are omitted.

If the determination result of step S802 is false, the process proceeds to step S804, where the microprocessor (202-1 to 211-1) selects an LED for the lower conveying path of the module that has received the instruction. Since the LED for the upper conveying path of each module is illustrated in FIG. 5B, the details are omitted.

In step S805, the microprocessor (202-1 to 211-1) determines whether to turn on or off the control target LED selected in step S803 or step S804. The information on the determination target is included in the analytical result of step S801.

If the determination result of step S805 is true, the process proceeds to step S807, where the control target LED selected in step S803 or S804 is turned on based on the lighting color information included in the result of analysis in step S801.

If the determination result of step S805 is false, the process proceeds to step S806, where the control target LED selected in step S803 or S804 is turned off.

FIG. 8B is a flowchart illustrating the operation when the microprocessors 201-1 of the image forming section 201 receives and processes an LED-on or LED-off instruction from the CPU 224, illustrated in FIG. 7.

In step S808, the microprocessor 201-1 determines the received instruction content. Specifically, the microprocessor 201-1 analyzes the information included in the instruction, including information on the control target LED, turning-on or turning-off, and lighting color.

In step S809, the microprocessor 201-1 determines whether the jam notification is for the head in the upper conveying path from the LED information included in the information obtained in step S808. If the determination result is true, the process proceeds to step S810, where the microprocessor 201-1 determines whether the jam notification is for the head or another portion in the upper conveying path. This is because only the image forming section 201 is provided with the two different LEDs 216-4 and 216-5) for the head and another portion in the upper conveying path.

If the determination result of step S810 is true, the process proceeds to step S811, where the microprocessor 201-1 selects the LED 216-4 for head in the upper conveying path of the image forming section 201, which is the module that has received the instruction, as the control target LED.

If the determination result of step S810 is false, the process proceeds to step S812, where the microprocessor 201-1 selects the LED 216-5 in the upper conveying path of the image forming section 201, which is the module that has received the instruction, as the control target LED.

The LEDs for the upper conveying path of the individual module are as illustrated in FIG. 5B. Redundant descriptions are omitted.

If the determination result of step S809 is false, the process proceeds to step S813, where the microprocessor 201-1 selects the LED 216-6 in the lower conveying path of the image forming section 201, which is the module that has received the instruction, as the control target LED. Since the LEDs for the lower conveying paths of the individual modules are illustrated in FIG. 5B, redundant descriptions are omitted.

In step S814, the microprocessor 201-1 determines whether to turn on or off the control target LED selected in step S811, S812, or step S813. The information on the determination target is included in the analytical result of step S808.

If the determination result of step S814 is true, the process proceeds to step S816, where the control target LED selected in step S811, S812, or S813 is turned on based on the lighting color information included in the result of analysis in step S808.

If the determination result of step S814 is false, the process proceeds to step S815, where the control target LED selected in step S811, S812, or S813 is turned off.

Such control enables the operator to determine in which module a sheet jam has occurred, if any, without checking the operation section 104 of the image forming apparatus 101. If a jam occurs in the upper conveying section, the LED corresponding to the upper conveying section lights up, and if a jam occurs in the lower conveying section, the LED corresponding to the lower conveying section lights up. This enables the operator to easily identify whether the jam has occurred in the upper conveying section or in the lower conveying section.

### Second Embodiment

The first embodiment describes a situation in which a single sheet is fed and a jam occurs at any point along the conveying path to the destination and a technique for detecting the module where the jam has occurred, identify the jam location in the conveying path, and presenting the information by turning on the LED corresponding to the identified module or jam location in the conveying path.

A second embodiment of the present invention describes a technique for detecting the module where a jam has occurred, if any, in an image forming apparatus that executes multiple continuous sheet feeding processes, identifying the jam location in the conveying path, selecting a target LED, and turning on the LED.

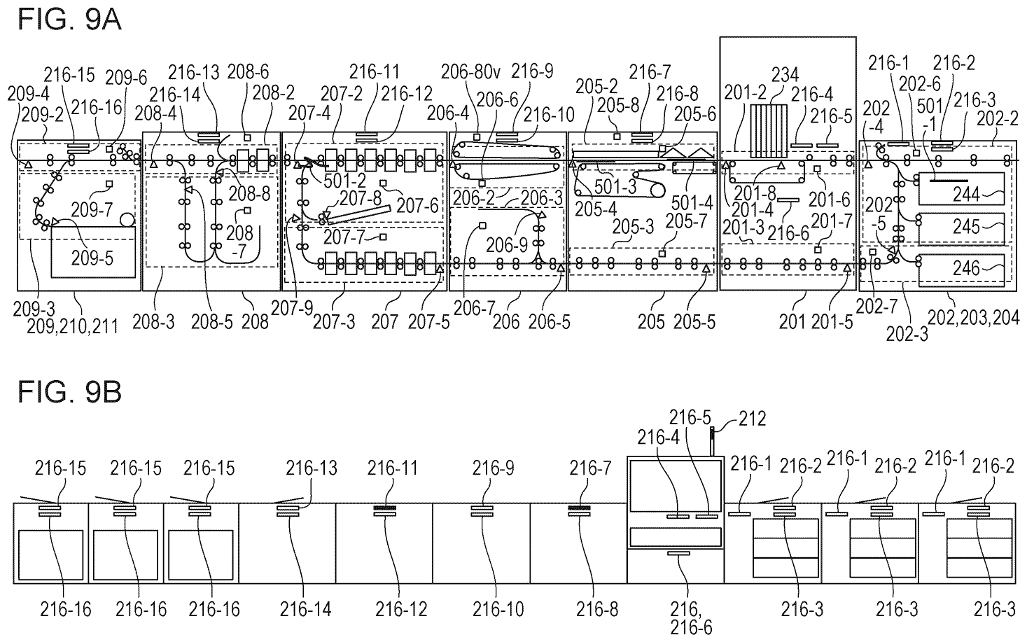

FIG. 9A illustrates a situation in which jams have occurred at multiple location in the image forming apparatus 101 during printing according to the second embodiment of the present invention. In this case, the information on the modules where the jams have occurred, the jam location in the modules, and the event type (jam) is simultaneously provided by multiple notification units (LEDs 216). Descriptions overlapping with FIG. 5A in the first embodiment are omitted.

FIG. 9B illustrates an example in which sheets 501-3 and 501-4 being conveyed are retained in the upper conveying section 205-2 of the first fixing section 205 into a jammed state because a sheet 501-2 is jammed in the upper conveying section 207-2 of the cooling section 207.

FIG. 9B illustrate an example of the lighting state of the LEDs 216 when the jam shown in FIG. 9A occurs in the image forming apparatus 101. As illustrated, the LED 216-7 corresponding to the upper conveying path 205-2 of the first fixing section 205 in which the jammed sheets 501-3 and 501-4 are present is turned on, in addition to the LED 216-11 corresponding to the upper conveying path 207-2 in the cooling section 207. This enables the operator to be notified that jammed sheets are present in multiple conveying paths in multiple modules.

A flowchart is omitted because it is shared with FIGS. 6, 7, and 8 in the first embodiment.

According to this embodiment, if jams occur at multiple locations in multiple modules, the operator can identify the multiple locations in the multiple modules all together. If the jams occur in the upper conveying section, the LEDs corresponding to the upper conveying section light up, and if the jams occur in the lower conveying section, the LEDs corresponding to the lower conveying section light up. This enables the operator to easily identify whether the jams have occurred in the upper conveying section or in the lower conveying section.

### Third Embodiment

A third embodiment of the present invention will be described hereinbelow. The image forming apparatus 101 according to the second embodiment of the present invention is configured such that, even if multiple jammed sheets are retained on multiple conveying paths in multiple modules, the multiple modules in which the jams have occurred and the conveying paths that require processes can be indicated by the LEDs 216.

The system according to the third embodiment provides a control mechanism for presenting information in sequence rather than at a time.

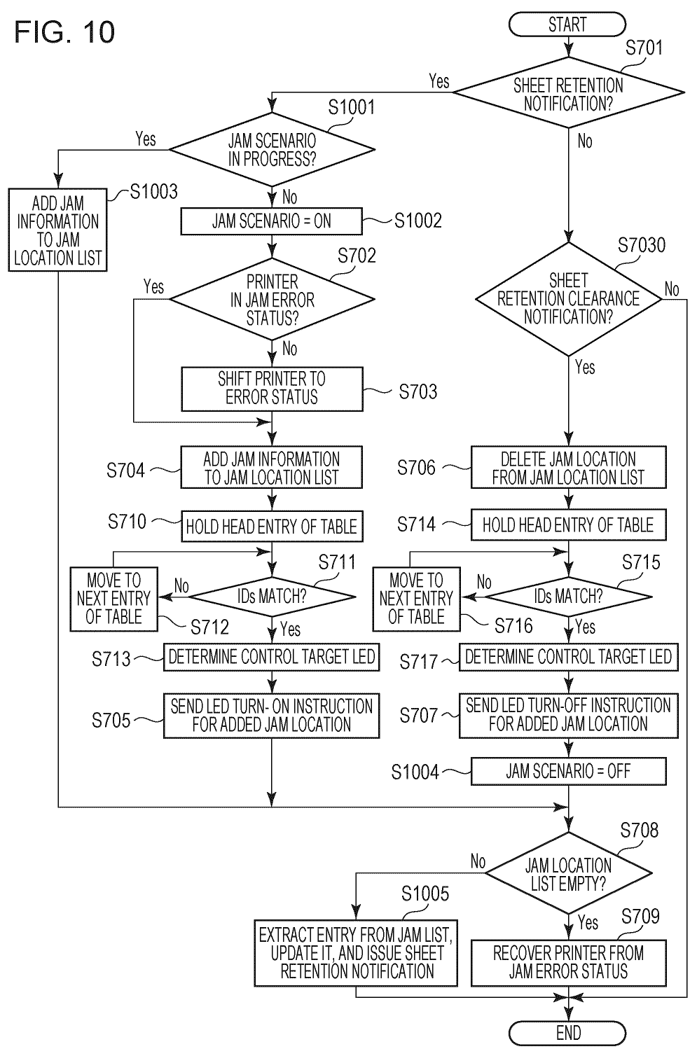

FIG. 10 is a flowchart illustrating the procedure of the processing of the third embodiment performed by the CPU 224 when the jam location list described with reference to FIG. 7 of the first embodiment is updated. The processing of the flowchart in FIG. 10 is performed by the CPU 224 reading various programs stored in the second SSD 221 into the second RAM 220 and executing them. When the CPU 224 detects the update of the jam location list, the processing of the flowchart is started. Descriptions of the processes overlapping with FIG. 7 of the first embodiment are omitted, and only the differences will be described hereinbelow.

If the notification that the CPU 224 received in step S701 is a sheet retention notification, the process proceeds to step S1001. In step S1001, the CPU 224 determines whether a recovery sequence, that is, a scenario for a jam that has already occurred, is in progress. If in step S1001 the CPU 224 determines that the scenario for jam recovery is not in progress, the process proceeds to step S1002. The CPU 224 sets a flag indicating that the jam recovery scenario is in progress and executes the processes from step S702 to step S705 in FIG. 7 of the first embodiment.

If the determination result of step S1001 is true, the process proceeds to step S1003, where the CPU 224 adds the jam information determined in step S701 to the list as a new jam location, and after completion of the adding process, the process proceeds to step S708. If the determination result of step S1001 is true, the processes from step S702 to step S705, which are executed when the determination result is false, are skipped. The processes from step S702 to step S705 include a LED turning-on process corresponding to the added jam location. However, this is to achieve sequential lighting control, where, if the jam scenario is in progress, the jam recovery targeted by the jam scenario is completed, the lit LED is turned off, and a new LED is lit as the next target for jam recovery.

After step S707 is completed, the process proceeds to step S1004, where the flag set in step S1002 is reset. If a sheet retention notification is received by the CPU 224 after the flag is reset in step S1004, the processes from step S1002 onward including an LED turning-on process are executed.

As a result of the determination in step S708, it is determined that the jam location list is not empty, the process proceeds to step S1005. In step S1005, the jam location determined by the system to require jam recovery next is deleted from the entries in the nonempty jam list and is sent to the CPU 224 as a sheet retention notification. If the notification sent in step S1005 is received by the CPU 224, the processing from step S701 of the flowchart is executed.

Thus, the processes from the LED turning-on process associated with the start of the jam recovery process to the LED turning-off process after the completion of the recovery are protected using the flag, thereby avoiding multiple execution of the process of turning on the LEDs at the jam locations. Consequently, the conveying paths in which jams have occurred are controlled so that corresponding LEDs light up in accordance with the order determined by the system.

According to this embodiment, even if multiple jammed sheets are retained on multiple conveying paths in multiple modules, the image forming apparatus 101 can indicate the multiple jammed modules and the conveying paths that require processes with the LEDs 216.

In other words, if sheet jams simultaneously occur in a first unit and a second unit, the sheet jam in the first unit is indicated first using the LED of the first unit, without indicating the sheet jam in the second unit. After the sheet jam in the first unit is cleared, the indication of the jam in the first unit using the LED is stopped, and the sheet jam in the second unit is indicated using the LED of the second unit. This enables the operator to check the jam locations in sequence and remove the jammed sheets.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-084791, filed May 24, 2024, which is hereby incorporated by reference herein in its entirety.

What is claimed is:

1. A printing system comprising:
an image forming apparatus; and
a sheet conveying apparatus configured to convey a sheet conveyed from the image forming apparatus,
wherein the sheet conveying apparatus includes a first sheet conveying path and a second sheet conveying path, and
wherein the sheet conveying apparatus includes a first display section that indicates a sheet jam in the first sheet conveying path and a second display section that indicates a sheet jam in the second sheet conveying path.

2. The printing system according to claim 1, wherein the first sheet conveying path is above the second sheet conveying path, and
wherein the first display section is above the second display section.

3. The printing system according to claim 1, wherein the first display section stops indicating the sheet jam in response to clearance of the sheet jam in the first sheet conveying path.

4. The printing system according to claim 1, further comprising:
another sheet conveying apparatus that receives a sheet conveyed by the sheet conveying apparatus and further conveys the received sheet,
wherein the other sheet conveying apparatus further includes another display section that indicates a sheet jam in the other sheet conveying apparatus.

5. The printing system according to claim 4, wherein, when a sheet jam in the first sheet conveying path and a sheet jam in the other sheet conveying apparatus occur simultaneously, indication of the sheet jam in the first sheet conveying path using the first display section and indication of the sheet jam in the other sheet conveying apparatus using the other display section are simultaneously provided.

6. The printing system according to claim 4,
wherein, when a sheet jam in the first sheet conveying path and a sheet jam in the other sheet conveying apparatus occur simultaneously, indication of the sheet jam in the first sheet conveying path using the other display section is not provided, and indication of the sheet jam in the other sheet conveying apparatus using the first display section is provided, and after the sheet jam in the first sheet conveying path is cleared, the indication of
the sheet jam in the first sheet conveying path using the first display section is stopped, and indication of the sheet jam in the other sheet conveying apparatus is provided by the other display section.

7. The printing system according to claim 1, wherein the display section comprises a light-emitting diode.

8. The printing system according to claim 4, wherein the display section and the other display section comprise a light-emitting diode.

9. The printing system according to claim 1,
wherein the image forming apparatus forms an image on the sheet, and
wherein the sheet conveying apparatus conveys the sheet on which the image is formed by the image forming apparatus and which is conveyed from the image forming apparatus.

10. A control method for a printing system including an image forming apparatus and
a sheet conveying apparatus configured to convey a sheet conveyed from the image forming apparatus, the sheet conveying apparatus including a first sheet conveying path and a second sheet conveying path, the method comprising:
indicating a sheet jam in the first sheet conveying path using a first display section of the sheet conveying apparatus; and
indicating a sheet jam in the second sheet conveying path using a second display section of the sheet conveying apparatus.

11. A computer-readable storage medium storing a computer-executable program for causing a computer to execute a control method for a printing system including an image forming apparatus and a sheet conveying apparatus configured to convey a sheet conveyed from the image forming apparatus, the sheet conveying apparatus including a first sheet conveying path and a second sheet conveying path, the method comprising:
indicating a sheet jam in the first sheet conveying path using a first display section of the sheet conveying apparatus; and
indicating a sheet jam in the second sheet conveying path using a second display section of the sheet conveying apparatus.
